(19) United States
(12) Patent Application Publication
(10) Pub. No.: US 2025/0249686 A1
(43) Pub. Date: Aug. 7, 2025

(54) LIQUID EJECTING DEVICE

(71) Applicant: SEIKO EPSON CORPORATION, Tokyo (JP)

(72) Inventor: Yasuo NARAMATSU, MATSUMOTO-SHI (JP)

(21) Appl. No.: 19/044,845

(22) Filed: Feb. 4, 2025

(30) Foreign Application Priority Data
Feb. 5, 2024 (JP) 2024-015421

(51) Int. Cl. B41J 2/17; B41J 3/407; B41M 7/00

(52) U.S. Cl. CPC B41J 2/1742; B41J 3/4078; B41M 7/0018

(57) ABSTRACT

A liquid ejecting device according to the present disclosure includes a liquid ejecting section configured to eject a liquid to a medium, and a liquid receiving section disposed at a position facing the liquid ejecting section across the medium, and configured to receive the liquid. The liquid receiving section includes a side surface portion rising upward from a bottom, and also includes a marker provided at an inner surface of the side surface portion.

The present application is based on, and claims priority from JP Application Serial Number 2024-015421, filed on Feb. 5, 2024, the disclosure of which is hereby incorporated by reference herein in its entirety.

### BACKGROUND

### 1. Technical Field

The present disclosure relates to a liquid ejecting device.

### 2. Related Art

As one example of this types of device, there is a printing apparatus described in JP-A-2018-130911.

JP-A-2018-130911 discloses a recessed portion disposed below a carriage, and an ink receiving section disposed in the recessed portion. Ink is jetted from a recording head to a medium, and the ink receiving section receives the ink that passes through the medium and moves downward.

Some media such as a synthetic fiber material or loosely-woven fabric are more likely to suffer ink strike-through. When printing is performed on such media that are more likely to suffer strike-through, the ink that has passed through to the other side builds up in the ink receiving section, resulting in waste ink.

However, in JP-A-2018-130911, collection of the waste ink building-up in the ink receiving section is not taken into consideration.

### SUMMARY

In order to solve the problem described above, a liquid ejecting device according to the present disclosure includes a liquid ejecting section configured to eject a liquid to a medium, and a liquid receiving section disposed at a position facing the liquid ejecting section across the medium, and configured to receive the liquid, in which the liquid receiving section includes a side surface portion rising upward from a bottom, and also includes a marker provided at an inner surface of the side surface portion.

### BRIEF DESCRIPTION OF THE DRAWINGS

FIG. 1 is an entire perspective view illustrating a liquid ejecting device according to first and second embodiments.

FIG. 2 is a configuration diagram illustrating main components of the first and second embodiments.

FIG. 3 is a configuration diagram illustrating main components of the first and second embodiments.

FIG. 4 is a perspective view illustrating a liquid receiving section according to the first embodiment.

FIG. 5 is a perspective view illustrating a liquid receiving section according to the second embodiment.

FIG. 6 is a perspective view illustrating a liquid receiving section according to the second embodiment.

FIG. 7 is a perspective view illustrating main components of the liquid receiving section according to the second embodiment.

FIG. 8 is a perspective view illustrating main components of the liquid receiving section according to the second embodiment.

FIG. 9 is a perspective view illustrating main components in a state where the liquid receiving section according to the second embodiment is held by a holding section.

FIG. 10 is an explanatory view illustrating a state where the liquid receiving section according to the second embodiment is detached from the holding section.

### DESCRIPTION OF EMBODIMENTS

First, the present disclosure will be schematically described below.

A liquid ejecting device according to a first aspect of the present disclosure includes a liquid ejecting section configured to eject a liquid to a medium, and a liquid receiving section disposed at a position facing the liquid ejecting section across the medium, and configured to receive the liquid, in which the liquid receiving section includes a side surface portion rising from a bottom, and also includes a marker provided at an inner surface of the side surface portion.

Here, the “marker” makes it possible to recognize an increase in the amount of a waste liquid building up as a result of reception of the liquid by the liquid receiving section. For example, the marker includes three-dimensional projections and depressions formed at the inner surface, a line or graphic or the like drawn at the inner surface, or the like.

With the present aspect, the liquid receiving section includes the side surface portion rising from the bottom and also includes the marker provided at an inner surface of the side surface portion. This configuration makes it possible to use the marker to determine whether or not the liquid receiving section is filled to capacity with the liquid even without providing a sensor for sensing the amount of the liquid building up in the liquid receiving section. Thus, it is possible to suppress an increase in the cost.

A liquid ejecting device according to a second aspect of the present disclosure is an aspect dependent on the first aspect, and includes a holding section configured to detachably hold the liquid receiving section, in which the side surface portion of the liquid receiving section is tilted outward from the bottom, and the side surface portion of the liquid receiving section is held by the holding section so as to be deformed in a direction in which an angle of the tilting reduces.

With the present aspect, the liquid receiving section is configured such that the side surface portion is tilted outward from the bottom, and the side surface portion of the liquid receiving section is held by the holding section so as to be deformed in a direction in which an angle of the tilting reduces. In other words, the side surface portion is held in a state where it is elastically pressed against the holding section. With this configuration, the posture in a state where the liquid receiving section is held is naturally fit, and is stabilized. In addition, it is possible to prevent the side surface portion of the liquid receiving section from falling over toward the inner side.

A liquid ejecting device according to a third aspect of the present disclosure is an aspect dependent on the first aspect, in which the liquid ejecting section includes an ink head configured to eject pigment ink, and also includes a treatment solution head configured to eject a treatment solution, and the liquid receiving section is configured such that the side surface portion provided at both end portions along a longitudinal direction of the bottom, and a side surface portion is not provided at both end portions along a short-length direction of the bottom.

Note that the present aspect can also be dependent on the second aspect.

Here, in the present specification, the expression “a side surface portion is not provided” in “a side surface portion is not provided at both end portions, in a short-length direction, of the bottom” means a structure in which both end portions of the bottom are exposed.

In addition, in the present specification, the “treatment solution” represents a thing that reacts in response to coming into contact with the pigment ink to reduce the fluidity of the pigment ink, and causes it to solidify with the passage of time.

With the present aspect, the liquid ejecting section includes the ink head configured to eject pigment ink and also includes the treatment solution head configured to eject a treatment solution. When coming into contact with the pigment ink, the treatment solution reacts to reduce the fluidity of the pigment ink, and causes it to solidify with the passage of time. This brings a liquid building-up in the liquid receiving section into a state of having the reduced fluidity or a state where it does not have any fluidity. This makes it possible to simplify the structure of the liquid receiving section, as compared with a case where it has fluidity.

This makes it possible for the liquid receiving section to have a structure in which the side surface portion is provided at both end portions along the longitudinal direction of the bottom, and a side surface portion is not provided at both end portions, along the short-length direction, of the bottom, as in the present aspect. In this manner, a side surface portion is not provided at both end portions, along the short-length direction, of the bottom, that is, both end portions along the short-length direction of the bottom are opened and are exposed. Thus, by disposing one liquid receiving section and another liquid receiving section so as to couple corresponding end portions of the bottoms of these sections, it is possible to easily elongate the entire length.

In addition, in the liquid receiving section, both end portions along the short-length direction of the bottom are opened and are exposed. This makes it possible to move in the longitudinal direction along the side surface portion. Thus, the accuracy of components is not demanded for positioning the posture when the liquid receiving section is mounted on a mounting target portion. This makes it possible to simplify the configuration of the liquid receiving section.

A liquid ejecting device according to a fourth aspect of the present disclosure is an aspect dependent on the first aspect, in which the marker is formed of a plurality of ribs provided at an inner surface of the side surface portion.

Note that the present aspect can also be dependent on the second aspect or the third aspect.

With the present aspect, the marker includes the plurality of ribs provided at the inner surface of the side surface portion, that is, is a three-dimensional marker. Thus, it is possible to easily visually recognize the marker.

In addition, portions between the plurality of ribs are grooves relatively to the ribs. Thus, these groove portions also function as the markers.

A liquid ejecting device according to a fifth aspect of the present disclosure is an aspect dependent on the fourth aspect, in which a recessed groove having a shape corresponding to the ribs is provided at an external surface side of the side surface portion of the ribs.

Here, the expression “a recessed groove having a shape corresponding to the ribs” means a structure in which, by providing a concave groove at one-side surface of a flat plate, a convex rib is formed at the other-side surface of the flat plate.

With the present aspect, a recessed groove having a shape corresponding to the ribs is provided at the external surface side of the side surface portion of the ribs. In other words, one of the ribs has a protruding-recessed structure in which the inner surface side has a raised shape and the external surface side has a recessed shape, and each of the plurality of ribs is configured to have the protruding-recessed structure.

This makes it possible to improve the bending rigidity, as compared with a case where the side surface portion of the liquid receiving section is formed into a flat plate shape. Thus, the rigidity of the liquid receiving section as a whole improves, which makes it possible to prevent the liquid receiving section from being distorted when a user holds it at the time of replacing it or the like. That is, the handleability of the liquid receiving section is favorable.

A liquid ejecting device according to a sixth aspect of the present disclosure is an aspect dependent on the fourth aspect, in which a longitudinal direction of the ribs is a vertical direction.

Note that the present aspect can also be dependent on the fifth aspect.

With the present aspect, the longitudinal direction of the ribs is a vertical direction. This configuration increases the bending rigidity in a direction in which force acts when a user holds the side surface portion at the time of replacing it or the like. This makes it possible to prevent the side surface portion from being distorted.

A liquid ejecting device according to a seventh aspect of the present disclosure is an aspect dependent on the fourth aspect, in which the liquid receiving section is provided with a bottom rib at the bottom, and the bottom rib is coupled to the ribs at the side surface portion.

Note that the present aspect can also be dependent on the fifth aspect or the sixth aspect.

With the present aspect, the liquid receiving section is provided with a bottom rib at the bottom, and the bottom rib is coupled to the ribs at the side surface portion. Thus, the rigidity of the bottom and both side surface portions as a whole is integrally improved. This improves the rigidity of the entire liquid receiving section, and the handleability is further improved.

A liquid ejecting device according to an eighth aspect of the present disclosure is an aspect dependent on the first aspect, in which a transparent portion configured to make the marker to be visually recognized is provided at a top surface portion positioned above the marker.

Note that the present aspect can also be dependent on any one of the second to the seventh aspects.

With the present aspect, the transparent portion configured to make the marker to be visually recognized is provided at the top surface portion positioned above the marker. This configuration makes it possible to visually recognize the liquid receiving section through the transparent portion over the top surface portion. Thus, it is possible to always monitor the state of the amount of the liquid building up in the liquid receiving section.

### EMBODIMENTS

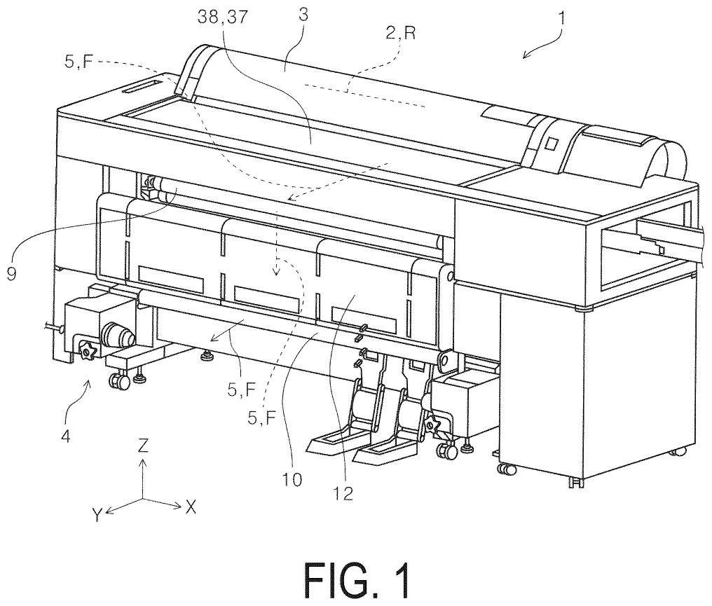

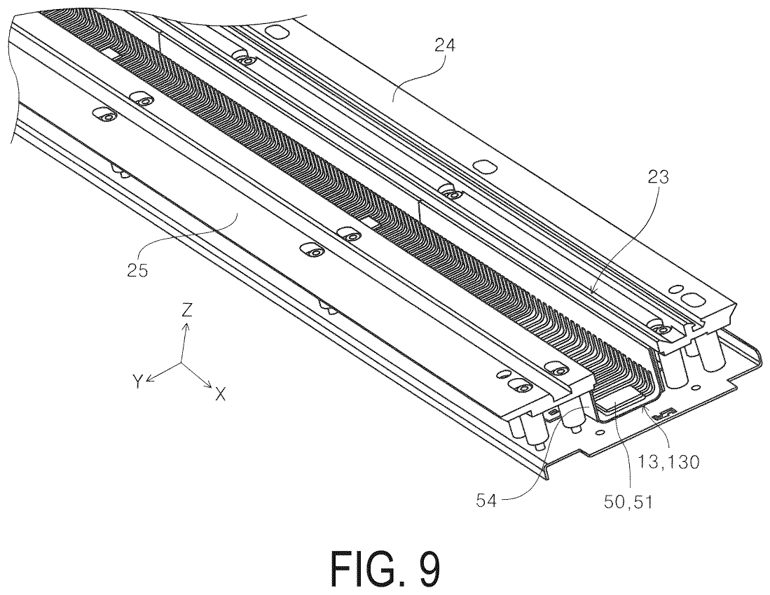

Below, embodiments of a liquid ejecting device according to the present disclosure will be described with reference to FIGS. 1 to 10.

In the following description, three axes that are orthogonal to each other are referred to as an X-axis, a Y-axis, and a Z-axis, respectively, as illustrated in each of the drawings. Directions of the arrows of the three axes (X, Y, and Z) indicate the +directions of the respective directions, and opposite directions are −directions. The Z-axis direction corresponds to a vertical direction, that is, a direction in which the gravity acts. The +Z direction indicates a vertically upward direction, and the −Z direction indicates a vertically downward direction. The X-axis direction and the Y-axis direction correspond to the horizontal direction. The +Y direction indicates a forward direction of the liquid ejecting device, and the −Y direction indicates a rearward direction of this device. The +X direction indicates a rightward direction of the device, and the −X direction indicates a leftward direction of the device.

### Entire Schematic Description of Liquid Ejecting Device

As illustrated in FIG. 1, a liquid ejecting device 1 according to the present embodiment is a device called a digital textile printer using fabric as a medium 2. This liquid ejecting device 1 uses a transport type called a roll-to-reel transport type to apply appropriate tension to the medium 2 to bring a recording region into a floating state.

The liquid ejecting device 1 includes a feeding section 3 disposed at an upper portion of the rear portion of the device, and also includes a winding section 4 disposed at a lower portion of the front portion of the device. A roll body R in which the medium 2 is wound in a roll form is set at the feeding section 3. As the feeding section 3 drives, the medium 2 is fed, and is transported in a transport direction F along a transport path 5.

In FIG. 1, the reference character 9 represents one intermediate roller that constitutes the transport path 5. The reference character 10 represents a guide bar configured to guide the medium 2 in a direction of the winding section 4.

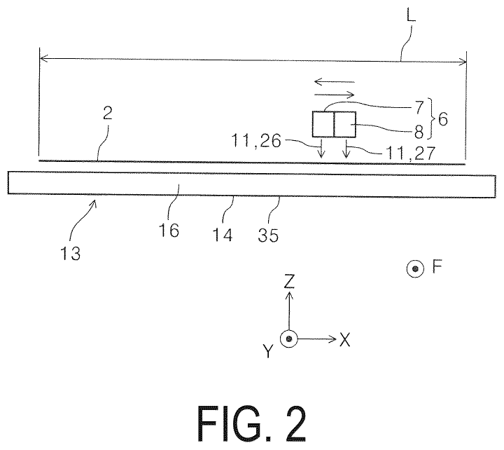

As illustrated in FIG. 2, a liquid ejecting section 6 is disposed along the transport path 5. The liquid ejecting section 6 includes an ink head 7 and a treatment solution head 8. The liquid ejecting section 6 is of a serial type configured to use a drive mechanism (not illustrated) to reciprocate in a direction (X-axis direction) that intersects the transport direction F. In FIG. 2, the reference character L represents a range for which a liquid 11 can be ejected by the reciprocating liquid ejecting section 6.

The medium 2 on which the liquid 11 is ejected by the liquid ejecting section 6 is wound up at a roll body (not illustrated) of the winding section 4. The reference character 12 represents a heating section. When the medium 2 on which the liquid 11 is ejected by the liquid ejecting section 6 is transported between the intermediate roller 9 and the guide bar 10, the heating section 12 heats it to perform a drying process.

### First Embodiment

The liquid ejecting device 1 according to the first embodiment will be described with reference to FIGS. 2 to 4.

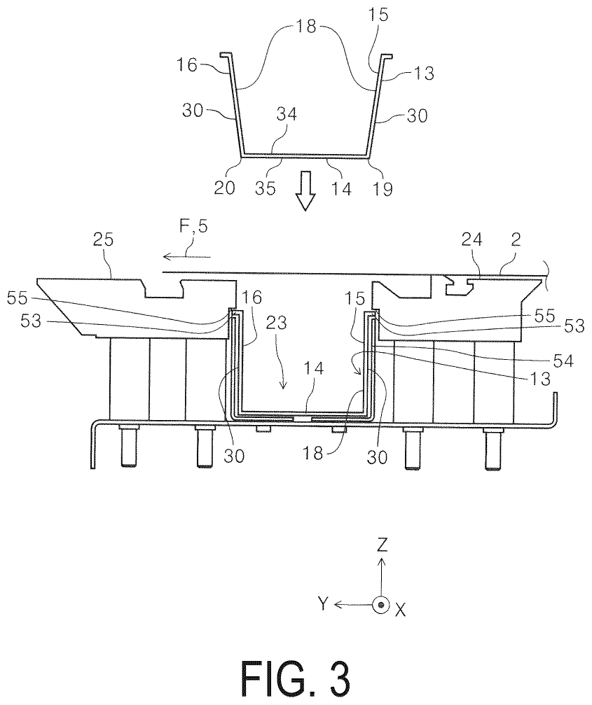

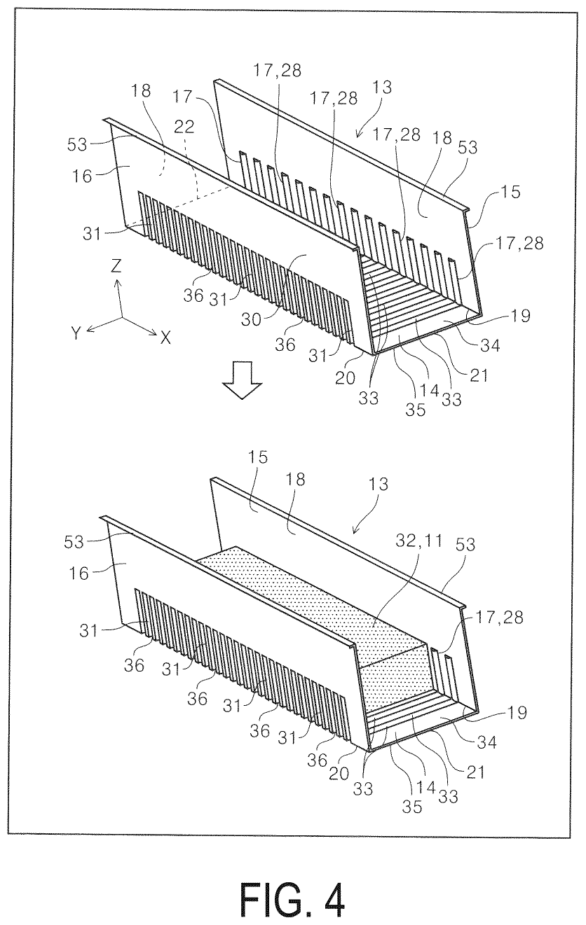

The liquid ejecting device 1 according to the present embodiment includes the liquid ejecting section 6 configured to eject the liquid 11 on the medium 2, and also includes a liquid receiving section 13 disposed at a position facing the liquid ejecting section 6 with the medium 2 being interposed between them and configured to receive the liquid 11. As illustrated in FIG. 2, the entire length of the liquid receiving section 13 is longer than the region L for which the liquid 11 can be ejected by the liquid ejecting section 6. As illustrated in FIGS. 3 and 4, the liquid receiving section 13 includes side surface portions 15 and 16 rising from a bottom 14, and also includes a marker 17 provided at each inner surface 18 of the side surface portions 15 and 16.

This liquid ejecting device 1 also performs printing on the medium 2 in which the liquid 11 ejected from the liquid ejecting section 6 is more likely to strike through to the back side, that is, on the medium 2 such as loosely-woven fabric having a large mesh. When printing is performed on such media 2 that are more likely to suffer strike-through to the back side, the liquid 11 that has passed through to the back side builds up in the liquid receiving section 13, resulting in a waste liquid 32 (FIG. 4). Types of the medium 2 include fabric, knit, nonwoven fabric, and the like. Of these types of media, when the liquid 11 is ejected on fabric that is more likely to suffer strike-through to the back side, the liquid passes through to the back side, and the liquid 11 builds up in the liquid receiving section 13.

In the present embodiment, the liquid receiving section 13 includes the side surface portions 15 and 16 provided at both end portions 19 and 20, in the longitudinal direction (X-axis direction), of the bottom 14 so as to extend toward an upper side, as illustrated in FIG. 4. In addition, no side surface portion is provided at both end portions 21 and 22, in the short-length direction (Y-axis direction), of the bottom 14. That is, the liquid receiving section 13 has a structure in which both end portions 21 and 22 of the bottom 14 are exposed, and has a letter-U shape as viewed from the X-axis direction. The liquid receiving section 13 may be used in a state where a plurality of liquid receiving sections 13 illustrated in FIG. 4 are coupled to each other in the longitudinal direction, or may be used as a long single unit without coupling them together.

Note that a side surface portion may be provided at both end portions 21 and 22 in the short-length direction (Y-axis direction) of the bottom 14. That is, a side surface portion may be provided at four sides of the bottom 14.

### Holding Section and Tilting Shape of Liquid Receiving Section

In the present embodiment, the liquid receiving section 13 is held by the holding section 23 in a detachable manner, as illustrated in FIG. 3. The holding section 23 is disposed at the lower face side of the transported medium 2. The holding section 23 is disposed between an upstream-side platen 24 and a downstream-side platen 25 that are disposed at the lower face side of the medium 2 transported in the transport direction F. A region between the upstream-side platen 24 and the downstream-side platen 25 corresponds to a region where the liquid 11 is ejected from the liquid ejecting section 6.

As illustrated in the upper section of FIG. 3, the side surface portions 15 and 16 of the liquid receiving section 13 are tilted outward from the bottom 14. That is, before the holding section 23 is attached, the liquid receiving section 13 has a shape in which the side surface portions 15 and 16 are opened outward. In addition, the liquid receiving section 13 is configured such that, when it is attached to the holding section 23, the side surface portions 15 and 16 are deformed in a direction in which an angle of the tilting reduces, and are held by the holding section 23. In the present embodiment, in a state where the liquid receiving section 13 is held by the holding section 23, the side surface portions 15 and 16 rise substantially upright relatively to the bottom 14.

### Pigment Ink and Treatment Solution

In addition, in the present embodiment, the ink head 7 of the liquid ejecting section 6 ejects pigment ink 26 serving as the liquid 11, as illustrated in FIG. 2. The treatment solution head 8 ejects a treatment solution 27 serving as the liquid 11. When coming into contact with the pigment ink 26, the treatment solution 27 reacts to reduce the fluidity of the pigment ink 26, and causes it to solidify with the passage of time.

As described above, the liquid receiving section 13 is configured such that the side surface portions 15 and 156 are provided at both end portions 19 and 20 along the longitudinal direction (X-axis direction) of the bottom 14, and no side surface portion is provided at both end portions 21 and 22 along the short-length direction (Y-axis direction) of the bottom 14. This is a structure that corresponds to the fact that, in a state of building up in the liquid receiving section 13, the pigment ink 26 and the treatment solution 27 is brought into a state where the fluidity of the pigment ink 26 reduces or the pigment ink 26 solidifies as described above.

### Marker

In the present embodiment, the marker 17 includes a plurality of ribs 28, 28, . . . provided at each inner surface 18 of the side surface portions 15 and 16, as illustrated in FIG. 4.

In the present embodiment, each external surface 30 side of the side surface portions 15 and 16 of the ribs 28, 28, . . . is a recessed groove 31, 31, . . . having a shape corresponding to the rib 28, 28, . . . . The “recessed groove 31, 31, . . . having a shape corresponding to the rib 28, 28, . . . ” means a structure in which, by providing a recessed groove 31 at one surface of a flat plate, a rib 28 having a protruding shape is formed at the other-side surface of the flat plate.

Specifically, the ribs 28, 28, . . . and the recessed grooves 31, 31, . . . are made by integrally molding a synthetic resin material using a forming die. Alternatively, they are made by subjecting a metal plate to a drawing process.

In addition, the longitudinal direction of the rib 28, 28 . . . provided at the side surface portions 15 and 16 is the vertical direction (Z-axis direction). For this reason, when the liquid 11 becomes the waste liquid 32 and starts to build up in the liquid receiving section 13, the ribs 28, 28 . . . serving as the marker 17 are gradually concealed, and finally disappear, as illustrated in the lower diagram in FIG. 4. That is, it is possible to grasp the situation of the increase in the amount of building-up of the waste liquid 32 every time visual recognition is made, which is convenient for use.

The present embodiment is designed such that the state where the marker 17 cannot be seen due to the waste liquid 32 corresponds to the timing of replacing the liquid receiving section 13.

Note that the longitudinal direction of the rib 28, 28 . . . may be the X-axis direction or may be other directions.

Furthermore, in the present embodiment, the liquid receiving section 13 is configured such that a bottom rib 33, 33, . . . is provided also at an inner surface 34 of the bottom 14, as illustrated in FIG. 4. The bottom rib 33, 33, . . . is coupled to the rib 28, 28, . . . at the side surface portions 15 and 16. The external surface 35 side of the bottom 14 of the bottom rib 33, 33, . . . is a recessed groove 36, 36, . . . having a shape corresponding to the bottom rib 33, 33, . . . .

In the present embodiment, the bottom ribs 33, 33, . . . and the recessed grooves 36, 36, . . . are made by integrally molding a synthetic resin material using a forming die. Alternatively, they are made by subjecting a metal plate to a drawing process.

Note that the marker 17 is provided to make it possible to recognize the increase in the amount of the waste liquid 32 building up as a result of reception of the liquid 11 by the liquid receiving section 13. Thus, the ribs 28, 28, . . . described above are not limited to those having a three-dimensional projections and depressions shape, and it may be possible to use a line or graphic or the like drawn at the inner surface 18.

In addition, in the present embodiment, a transparent portion 38 configured to make it possible to visually recognize the marker 17 provided at the side surface portions 15 and 16 of the liquid receiving section 13 is provided at a top surface portion 37 positioned above the marker 17, as illustrated in FIG. 1. Here, the whole of the top surface portion 37 is made of a transparent member, and the top surface portion 37 itself constitutes the transparent portion 38. It is sufficient that the transparent portion 38 allows the marker 17 of the liquid receiving section 13 to be visually recognized through the top surface portion 37. Thus, the whole of the top surface portion 37 may not be made of a transparent member.

### Description of Effects of First Embodiment

(1) In the present embodiment, the liquid receiving section 13 includes the side surface portions 15 and 16 rising upward from the bottom 14, and also includes the marker 17 provided at the inner surface 18 of the side surface portions 15 and 16. This configuration makes it possible to determine whether or not the liquid receiving section 13 is filled to capacity with the liquid 11 using the marker 17 even without providing a sensor for sensing the amount of the liquid 11 building up in the liquid receiving section 13. Thus, it is possible to suppress an increase in the cost.

(2) In addition, in the present embodiment, the liquid receiving section 13 is configured such that the side surface portions 15 and 16 are deformed in a direction in which an angle of the tilting reduces, and is held by the holding section 23. In other words, the side surface portions 15 and 16 are held in a state where they are elastically pressed against the holding section 23. With this configuration, the posture in a state where the liquid receiving section 13 is held is naturally fit, and is stabilized. In addition, it is possible to prevent the side surface portions 15 and 16 of the liquid receiving section 13 from falling over toward the inner side.

(3) Furthermore, in the present embodiment, the liquid ejecting section 6 includes the ink head 7 configured to eject the pigment ink 26, and also includes the treatment solution head 8 configured to eject the treatment solution 27. When coming into contact with the pigment ink 26, the treatment solution 27 reacts to reduce the fluidity of the pigment ink 26, and causes it to solidify with the passage of time. This brings the liquid 11 building-up as the waste liquid 32 in the liquid receiving section 13 into a state of having the reduced fluidity or a state where it does not have any fluidity. This makes it possible to simplify the structure of the liquid receiving section 13, as compared with a case where it has fluidity.

This enables the liquid receiving section 13 to have a structure in which the side surface portions 15 and 16 are provided at both end portions 19 and 20 along the longitudinal direction of the bottom 14, and no side surface portion is provided at both end portions 21 and 22 along the short-length direction of the bottom 14, as in the present embodiment. In this manner, no side surface portion is provided at both end portions 21 and 22 along the short-length direction of the bottom 14, that is, both end portions 21 and 22 along the short-length direction of the bottom 14 are opened and are exposed. Thus, by disposing one liquid receiving section 13 and another liquid receiving section 13 so as to couple corresponding end portions of the bottoms 14 of these sections, it is possible to easily elongate the entire length.

Furthermore, the liquid receiving section 13 is configured such that both end portions 21 and 22 along the short-length direction of the bottom 14 are exposed. This makes it possible to move the liquid receiving section 13 in the longitudinal direction along the side surface portions 15 and 16. For this reason, the accuracy of components is not demanded for positioning the posture when the liquid receiving section 13 is mounted on a mounting target portion of the holding section 23. Thus, it is possible to simplify the configuration of the liquid receiving section 13.

(4) In addition, in the present embodiment, the marker 17 includes the plurality of ribs 28, 28, . . . provided at the inner surface 18 of the side surface portions 15 and 16, that is, is a three-dimensional marker 17. Thus, it is possible to easily visually recognize the marker 17.

Furthermore, portions between the plurality of ribs 28, 28, . . . are grooves relatively to the ribs 28, 28, . . . . These groove portions can also function as the markers 17.

(5) In addition, in the present embodiment, the external surface 30 side of the side surface portions 15 and 16 of the ribs 28, 28, . . . is the recessed groove 31, 31, . . . having a shape corresponding to the rib 28, 28, . . . . In other words, one rib 28 has a protruding-recessed structure in which the inner surface 18 side has a raised shape and the external surface 30 side has a recessed shape, and each of the plurality of ribs 28, 28, . . . is configured to have the protruding-recessed structure.

This makes it possible to improve the bending rigidity, as compared with a case where the side surface portions 15 and 16 of the liquid receiving section 13 are formed into a flat plate shape. Thus, the rigidity of the liquid receiving section 13 as a whole improves, which makes it possible to prevent the liquid receiving section 13 from being distorted when a user holds it at the time of replacing it or the like. That is, the handleability of the liquid receiving section 13 is favorable.

(6) Furthermore, in the present embodiment, the longitudinal direction of the rib 28, 28 . . . is the vertical direction (Z-axis direction). Thus, it is possible to increase the bending rigidity in a direction in which force acts when a user holds the side surface portions 15 and 16 at the time of replacing it or the like. This makes it possible to prevent the side surface portions 15 and 16 from being distorted.

(7) In addition, in the present embodiment, the liquid receiving section 13 is configured such that the bottom rib 33, 33, . . . is provided also at the bottom 14, and the bottom rib 33, 33, . . . is coupled to the rib 28, 28, . . . at the side surface portions 15 and 16. Thus, the rigidity of the bottom 14 and both side surface portions 15 and 16 as a whole is integrally improved. This improves the rigidity of the liquid receiving section 13 as a whole, and the handleability is further improved.

(8) Furthermore, in the present embodiment, the transparent portion 38 configured to allow the marker 17 to be visually recognized is provided at the top surface portion 37 positioned d above the marker 17. This configuration makes it possible to visually recognize the liquid receiving section 13 through the transparent portion 38 over the top surface portion 37. Thus, it is possible to always monitor the state of the amount of the waste liquid 32 building up in the liquid receiving section 13.

### Second Embodiment

Next, a liquid ejecting device 1 according to a second embodiment will be described with reference to FIGS. 1 to 10. The same reference characters are attached to the same components as those in the first embodiment, and description of the configurations and corresponding effects will not be repeated.

Although description is made partially again, the liquid ejecting device 1 according to the present embodiment includes the liquid ejecting section 6 configured to eject the liquid 11 to the medium 2, and also includes the liquid receiving section 13 disposed at a position facing the liquid ejecting section 6 with the medium 2 being interposed between them and configured to receive the liquid 11, as illustrated in FIGS. 2 and 3.

The liquid ejecting section 6 includes the ink head 7 configured to eject the pigment ink 26, and also includes the treatment solution head 8 configured to eject the treatment solution 27.

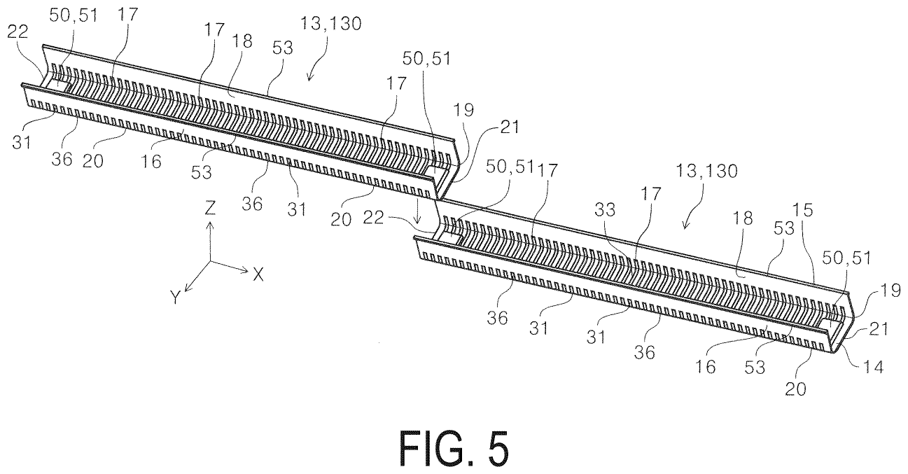

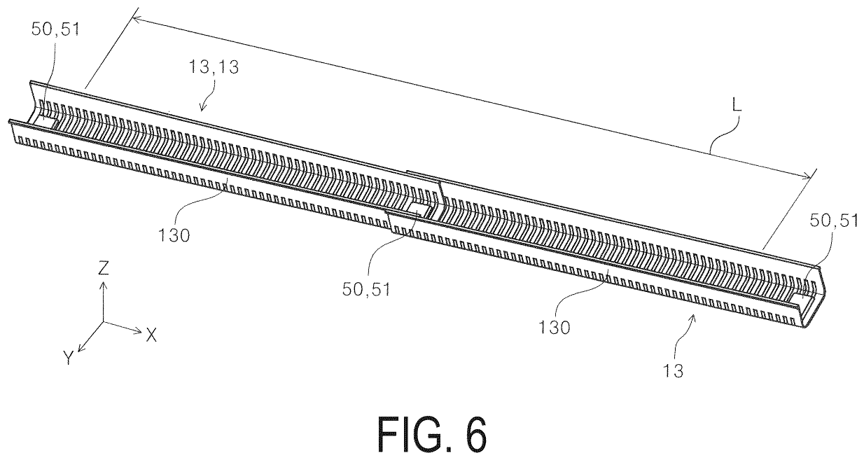

As illustrated in FIGS. 5 and 6, the liquid receiving section 13 is configured such that the side surface portions 15 and 16 are provided at both end portions 19 and 20, in the longitudinal direction (X-axis direction), of the bottom 14 so as to extend toward an upper side. In addition, no side surface portion is provided at both end portions 21 and 22, in the short-length direction (Y-axis direction), of the bottom 14.

Here, illustration is made of a structure in which the markers 17, 17, . . . are provided at the side surface portions 15 and 16 in a manner similar to that of the first embodiment. However, it may be possible to employ a structure in which these markers 17, 17, . . . are not provided.

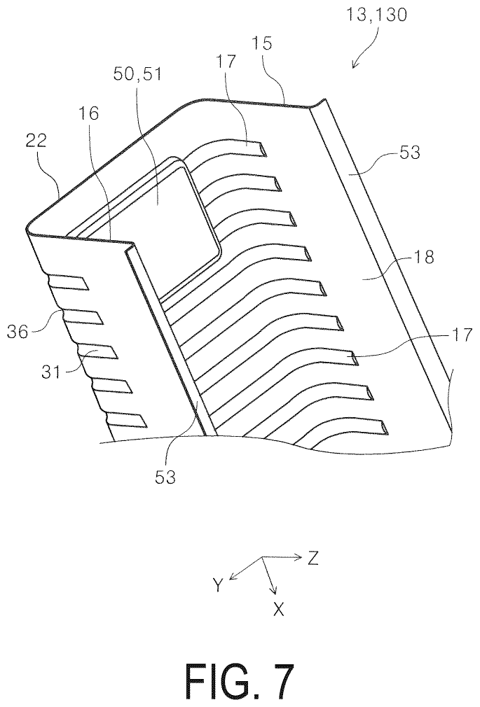

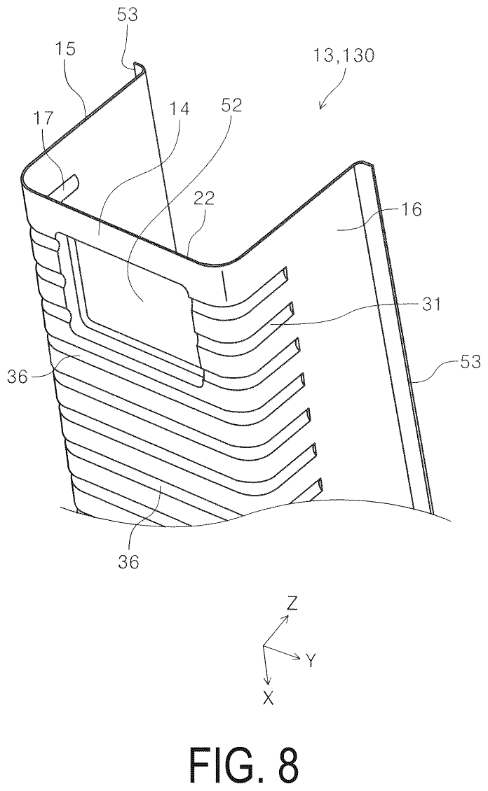

In the present embodiment, the liquid receiving section 13 includes a protrusion portion 50 disposed at each end portion 21, 22 in the longitudinal direction (X-axis direction) of the bottom 14, as illustrated in FIGS. 5 and 6. The protrusion portion 50 is configured such that the upper face side (+Z) of the bottom 14 has a raised shape 51 (FIG. 7), and the lower face side has a recessed shape 52 corresponding to the raised shape 51, as illustrated in FIGS. 7 and 8. The raised shape 51 and the recessed shape 52 of the protrusion portion 50 are made by integrally molding a synthetic resin material using a forming die. Alternatively, they are made by subjecting a metal plate to a drawing process.

As illustrated in FIGS. 5 and 6, the liquid receiving section 13 includes a plurality of unit liquid receiving sections 130, 130, . . . . In addition, the bottom 14 of one unit liquid receiving section 130 is coupled to the bottom 14 of another unit liquid receiving section 130 in an overlapping state.

In the present embodiment, the protrusion portion 50 is disposed at the overlapping portion of the bottom 14. As described above, the protrusion portion 50 is configured such that the upper face side of the bottom 14 has the raised shape 51, and the lower face side has the recessed shape 52 corresponding to the raised shape 51. The present embodiment is configured such that a portion of the raised shape 51 of one unit liquid receiving section 130 is fitted with a portion of the recessed shape 52 of another unit liquid receiving section 130 to couple them to each other.

Note that the configuration is not limited to the structure in which the raised shape 51 of the protrusion portion 50 and the recessed shape 52 of the protrusion portion 50 are fitted with each other to couple them to each other.

In the present embodiment, the liquid receiving section 13 includes a flange portion 53 provided at an upper end of the side surface portion 15, 16, as illustrated in FIGS. 5 and 6. The flange portion 53 is configured so as to be able to function as a handle.

In addition, the holding section 23 configured to detachably hold the liquid receiving section 13 includes an engagement portion 55 configured to engage with an upper surface of the flange portion 53 in a state where the liquid receiving section 13 is attached, as illustrated in FIG. 3. Here, the engagement portion 55 is provided at the upstream-side platen 24 and the downstream-side platen 25. The upper surface of the flange portion 53 engages with the engagement portion 55, that is, is pressed from above by the engagement portion 55, whereby the attachment state of the liquid receiving section 13 is stabilized.

The holding section 23 includes a support portion 54 configured to receive the liquid receiving section 13 to support the bottom 14 and the side surface portions 15 and 16, as illustrated in FIGS. 3, 4, 9, and 10. The support portion 54 includes a surface configured to come into contact with the external surface 35 of the bottom 14 of the liquid receiving section 13 and each of the external surfaces 30 and 30 of the side surface portions 15 and 16. That is, the support portion 54 has a letter-U shape as with the liquid receiving section 13.

Note that, for the purpose of facilitating understanding of the drawing, FIG. 3 illustrates a state where the inner surface of the support portion 54 is not in contact with the external surface of the liquid receiving section 13. However, in reality, both are in contact with each other in a state where they are elastically pressed against each other.

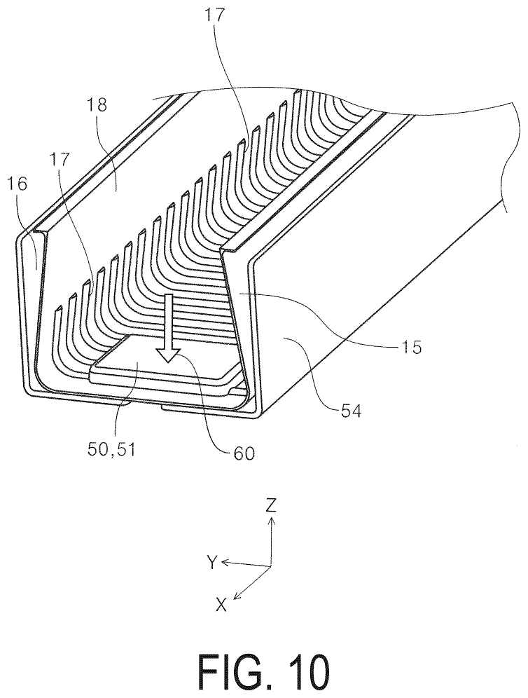

As illustrated in FIG. 10, by pushing the protrusion portion 50 from above as illustrated by the arrow 60 to deform it when the liquid receiving section 13 is in a state of being held by the holding section 23, here, in a state of being supported by the support portion 54, the side surface portions 15 and 16 fall inward due to this deformation. As the side surface portions 15 and 16 fall inward in this manner, the flange portion 53 disengages from the engagement portion 55. Thus, it is possible to easily detach the flange portion 53 from the holding section 23 by pinching it.

### Description of Effect of Second Embodiment

(1) In the present embodiment, the liquid ejecting section 6 includes the ink head 7 configured to eject the pigment ink 26, and also includes the treatment solution head 8 configured to eject the treatment solution 27. When coming into contact with the pigment ink 26, the treatment solution 27 reacts to reduce the fluidity of the pigment ink 26, and causes it to solidify with the passage of time. This brings the liquid 11 building-up as the waste liquid 32 in the liquid receiving section 13 into a state of having the reduced fluidity or a state where it does not have any fluidity. This makes it possible to simplify the structure of the liquid receiving section 13, as compared with a case where it has fluidity.

Thus, as in the present embodiment, the liquid receiving section 13 is able to have a structure in which the side surface portions 15 and 16 are provided at both end portions 19 and 20 along the longitudinal direction (X-axis direction) of the bottom 14, and no side surface portion is provided at both end portions 21 and 22 along the short-length direction (Y-axis direction) of the bottom 14. In this manner, no side surface portion is provided at both end portions 21 and 22 along the short-length direction of the bottom 14, that is, both end portions 21 and 22 along the short-length direction of the bottom 14 are opened and are exposed. Thus, by coupling the end portion 21 of the bottom 14 of one liquid receiving section 13 and the end portion 22 of the bottom 14 of another liquid receiving section 13 and disposing them, it is possible to easily elongate the entire length.

Furthermore, the liquid receiving section 13 is configured such that both end portions 21 and 22 along the short-length direction of the bottom 14 are exposed. This makes it possible to move the liquid receiving section 13 in the longitudinal direction (X-axis direction) along the side surface portions 15 and 16. For this reason, the accuracy of components is not demanded for positioning the posture when the liquid receiving section 13 is mounted on the mounting target portion of the holding section 23. Thus, it is possible to simplify the configuration of the liquid receiving section 13.

(2) In addition, in the present embodiment, the liquid receiving section 13 is configured such that the side surface portions 15 and 16 are deformed in a direction in which an angle of the tilting reduces, and is held by the holding section 23. In other words, the side surface portions 15 and 16 are held in a state of being elastically pressed against the holding section 23. With this configuration, the posture in a state where the liquid receiving section 13 is held is naturally fit, and is stabilized. In addition, it is possible to prevent the side surface portions 15 and 16 of the liquid receiving section 13 from falling over toward the inner side.

(3) Furthermore, in the present embodiment, the protrusion portion 50 disposed at the end portions 21 and 22 in the longitudinal direction (X-axis direction) of the bottom 14 is configured such that the upper face side of the bottom 14 has the raised shape 51, and the lower face side has the recessed shape 52 corresponding to the raised shape 51. With this configuration, by pushing the protrusion portion 50 from above, the side surface portions 15 and 16 of the liquid receiving section 13 falls inwardly, which enables the side surface portions 15 and 16 to be pinched. This makes it possible to easily take the liquid receiving section 13 out even if there is no mechanism for taking it out, which makes the replacement easy.

(4) Furthermore, in the present embodiment, the liquid receiving section 13 is configured such that the bottom 14 of one of the unit liquid receiving sections 130 is coupled to the bottom 14 of another one of the unit liquid receiving sections 130 in an overlapping state. This configuration makes it possible to easily achieve coupling to elongate the entire length in a state where the risk of leaking of a liquid from the coupling portion is reduced. (5) In addition, in the present embodiment, the protrusion portion 50 disposed at an overlapping portion of the bottom 14 has the raised shape 51 at an upper face side of the bottom 14 and also has the recessed shape 52 at a lower face side, and the recessed shape 52 corresponds to the raised shape 51. With this configuration, by pushing the protrusion portion 50, the side surface portions 15 and 16 of the liquid receiving section 13 falls inwardly, which enables the side surface portions 15 and 16 to be pinched. This makes it possible to easily take the liquid receiving section 13 out even if there is no mechanism for taking it out, which makes the replacement easy.

In addition, a portion of the raised shape 51 of one of the unit liquid receiving sections 130 is fitted with a portion of the recessed shape 52 of another one of the unit liquid receiving sections 130 to couple these portions. That is, protrusion portions 50 are fitted with each other, and are coupled to each other. This makes it possible to reduce the possibility that the coupling of these portions is unexpectedly disengaged.

Furthermore, of the pair of protrusion portions 50 that are fitted with each other, a protrusion portion 50 disposed at the lower portion does not suffer attachment of the liquid 11. Thus, it is easy to handle this protrusion portion. In addition, the liquid 11 does not adhere to the protrusion portion 50 disposed outside the range L in which the liquid 11 can be ejected by the liquid ejecting section 6. Thus, it is easy to handle it at the time of replacement or the like.

(6) Furthermore, in the present embodiment, since the flange portion 53 is provided at the upper end of the side surface portions 15 and 16, the flange portion 53 serves as a handle, which makes handling easy at the time of replacement.

(7) In addition, in the present embodiment, the holding section 23 includes the engagement portion 55 configured to engage with the upper surface of the flange portion 53 in a state where the liquid receiving section 13 is attached. This configuration makes it possible to prevent the liquid receiving section 13 from unexpectedly being detached in a state where the liquid receiving section 13 is held by the holding section 23.

(8) Furthermore, in the present embodiment, the holding section 23 includes the support portion 54 configured to receive the liquid receiving section 13 to support the bottom 14 and the side surface portions 15 and 16. That is, the liquid receiving section 13 is supported by the support portion 54 in a state where the bottom 14 and the side surface portions 15 and 16 are supported. This configuration makes it possible to reduce the possibility of deformation of the entire shape even if the amount of liquid 11 built-up in the liquid receiving section 13 increases. Thus, it is possible to stably keep the liquid 11.

### OTHER EMBODIMENTS

The liquid ejecting device 1 according to the present disclosure is based on the configuration of the embodiments described above. However, it is needless to say that it is possible to change or omit a part of the configuration without departing from the main point of the present disclosure.

What is claimed is:

1. A liquid ejecting device, comprising:
a liquid ejecting section configured to eject a liquid to a medium; and
a liquid receiving section disposed at a position facing the liquid ejecting section across the medium, and configured to receive the liquid, wherein
the liquid receiving section includes:
a side surface portion rising from a bottom; and
a marker provided at an inner surface of the side surface portion.

2. The liquid ejecting device according to claim 1, comprising
a holding section configured to detachably hold the liquid receiving section, wherein
the side surface portion of the liquid receiving section is tilted outward from the bottom, and
the side surface portion of the liquid receiving section is held by the holding section so as to be deformed in a direction in which an angle of the tilting reduces.

3. The liquid ejecting device according to claim 1, wherein
the liquid ejecting section includes:
an ink head configured to eject a pigment ink; and
a treatment solution head configured to eject a treatment solution, and
the liquid receiving section is provided with:
the side surface portion at both end portions along a longitudinal direction of the bottom; and
no side surface portion at both end portions along a short-length direction of the bottom.

4. The liquid ejecting device according to claim 1, wherein
the marker is formed of a plurality of ribs provided at an inner surface of the side surface portion.

5. The liquid ejecting device according to claim 4, wherein
a recessed groove having a shape corresponding to the rib is provided at an external surface side of the side surface portion of the rib.

6. The liquid ejecting device according to claim 4, wherein a longitudinal direction of the rib is a vertical direction.

7. The liquid ejecting device according to claim 4, wherein
the liquid receiving section is provided with a bottom rib at the bottom, and
the bottom rib is coupled to the rib at the side surface portion.

8. The liquid ejecting device according to claim 1, wherein
a transparent portion configured to make the marker to be visually recognized is provided at a top surface portion positioned above the marker.
